(19) United States
(12) Patent Application Publication
(10) Pub. No.: US 2026/0197574 A1
(43) Pub. Date: Jul. 9, 2026

(54) SOUND OUTPUT DEVICE FOR LAMP AND LAMP SYSTEM INCLUDING THE SAME

(71) Applicant: Hyundai Mobis Co., Ltd., Seoul (KR)

(72) Inventor: Myeong Je KIM, Yongin-si (KR)

(73) Assignee: Hyundai Mobis Co., Ltd., Seoul (KR)

(21) Appl. No.: 19/333,235

(22) Filed: Sep. 18, 2025

(30) Foreign Application Priority Data
Jan. 9, 2025 (KR) 10-2025-0003362

(51) Int. Cl. H04R 1/02; F21V 33/00; H04R 1/22; H04R 17/00

(52) U.S. Cl. CPC H04R 1/028; F21V 33/0056; H04R 1/22; H04R 17/00; H04R 2499/13

(57) ABSTRACT

The present invention relates to a sound output device for a lamp and a lamp system including the same, and more particularly, to a device including a piezoelectric element stack including a plurality of piezoelectric elements stacked together, a sound driving circuit configured to drive the piezoelectric element stack, and a signal processing circuit connected between the sound driving circuit and the piezoelectric element stack, wherein the signal processing circuit includes an impedance compensation filter configured to compensate for an impedance of the piezoelectric element stack that varies according to an output of the sound driving circuit, and the impedance compensation filter includes reactance components excluding resistive elements.

### CROSS REFERENCE TO RELATED APPLICATION

The present application claims priority to and the benefit under 35 USC § 119 (a) of Korean Patent Application No. 10-2025-0003362, filed Jan. 9, 2025, in the Korean Intellectual Property Office, the disclosure of which is incorporated herein by reference in its entirety for all purposes.

### BACKGROUND

### Field

The present invention relates to a sound output device for a lamp and a lamp system including the same, and more particularly, to a sound output device for a lamp provided in a vehicle and a lamp system including the same.

### Description of the Related Art

In the recent vehicle exterior speaker market, technologies that combine video and sound for effective information delivery are drawing significant attention. Amid this trend, efforts to adopt piezoelectric elements as exterior speakers are emerging as a promising direction, but several technical challenges must be addressed for successful implementation.

Since exterior speakers are used outside the vehicle, delivering high output power is essential. To satisfy this requirement, the electrical capacitance of the piezoelectric element must be at least 1 μF; however, conventional piezoelectric elements, though well-suited for high-frequency applications, exhibit limitations in achieving increased capacitance. To overcome this limitation, a multilayer stacking method is employed to increase the capacitance.

This method involves stacking multiple layers of piezoelectric elements to enhance the electrical capacitance, thereby effectively satisfying the output requirement. However, the multilayer stacking method alters the impedance characteristics across frequencies, causing the impedance to decrease in the high-frequency region. As impedance decreases, the risk of overcurrent increases, which in turn compromises the stability of the element and raises the risk of overheating or damage.

To mitigate this issue, a technique of incorporating a series resistor to limit peak current is adopted. A series resistor can ensure the stability of the element by limiting current at high frequencies, but this approach entails reduced efficiency due to increased power consumption and heat generation caused by the resistor.

Ultimately, to utilize a piezoelectric element as an exterior speaker, a control method capable of managing a piezoelectric element with both high capacitance and low impedance is required.

### SUMMARY

The present invention has been conceived to solve the above problems, and an object of the present invention is to provide a sound output device for a lamp and a lamp system including the same, capable of outputting sound within a sealed structure of the lamp without using a conventional speaker.

In order to accomplish the above object, a sound output device for a lamp according to various embodiments of the present invention includes a piezoelectric element stack including a plurality of piezoelectric elements stacked together, a sound driving circuit configured to drive the piezoelectric element stack, and a signal processing circuit connected between the sound driving circuit and the piezoelectric element stack, wherein the signal processing circuit includes an impedance compensation filter configured to compensate for an impedance of the piezoelectric element stack that varies according to an output of the sound driving circuit, and the impedance compensation filter includes reactance components, excluding resistive elements.

In addition, the impedance compensation filter includes an inductor having one end connected to the sound driving circuit and the other end connected to the piezoelectric element stack, wherein the inductor is configured to compensate for the impedance of the piezoelectric element stack and maintain the impedance of the piezoelectric element stack equal to or greater than a predetermined threshold at frequencies above a predetermined reference frequency.

In addition, the signal processing circuit further includes a frequency selection circuit connected between the sound driving circuit and the impedance compensation filter, wherein the frequency selection circuit is configured to selectively pass signals of a specific frequency band in response to an output from the sound driving circuit.

In addition, the frequency selection circuit includes a low-pass filter configured to pass only frequency components lower than a preset cutoff frequency.

In addition, the inductor compensates for the impedance of the piezoelectric element stack and maintains the impedance of the piezoelectric element stack at 4 ohms or more in a frequency band of 4 kHz or higher.

In addition, a resonance frequency of the inductor is higher than 20 KHz, which is an audible frequency.

In addition, the low-pass filter includes a first inductor and a first capacitor connected between a first output terminal of the sound driving circuit and a first terminal of the piezoelectric element stack, the first capacitor being grounded and disposed between the first inductor and the piezoelectric element stack, and a second inductor and a second capacitor connected between a second output terminal of the sound driving circuit and a second terminal of the piezoelectric element stack, the second capacitor being grounded and disposed between the second inductor and the piezoelectric element stack.

In addition, the cutoff frequency fc of the low-pass filter is determined based on an inductance L of the inductor, a capacitance C of the capacitor, and an internal capacitance Cp of the piezoelectric element stack, and is defined by Equation 1:

$${f}_{c} = \frac{1}{2 π \sqrt{L ( C + 2 {C}_{p} )}} ,$$

where L refers to the inductance of either the first or second inductor, C refers to the capacitance of either the first or second capacitor, and Cp refers to the internal capacitance of the piezoelectric element.

In addition, the low-pass filter includes a first inductor and a second inductor respectively connected in series between a first output terminal and a second output terminal of the sound driving circuit and a first terminal and a second terminal of the piezoelectric element stack, the first inductor being connected between the first output terminal of the sound driving circuit and the first terminal of the piezoelectric element stack, and the second inductor being connected between the second output terminal of the sound driving circuit and the second terminal of the piezoelectric element stack.

In addition, the cutoff frequency fc of the low-pass filter is determined based on an inductance L of the inductor and an internal capacitance Cp of the piezoelectric element stack, and is defined by Equation 2:

$${f}_{c} = \frac{1}{2 π \sqrt{L ( 2 {C}_{p} )}} ,$$

where L refers to the inductance of either the first or second inductor, and Cp refers to the internal capacitance of the piezoelectric element stack.

In addition, the low-pass filter includes a first inductor and a second inductor connected in series between an output terminal of the sound driving circuit and a first terminal of the piezoelectric element stack.

In addition, the cutoff frequency fc of the low-pass filter is determined based on an inductance L of the inductor and an internal capacitance Cp of the piezoelectric element stack, and is defined by Equation 3:

$${f}_{c} = \frac{1}{2 π \sqrt{2 L ( {C}_{p} )}} ,$$

where L refers to the inductance of either the first or second inductor, and Cp refers to the internal capacitance of the piezoelectric element stack.

In addition, the capacitance of the piezoelectric element stack is equal to or greater than 1 μF.

In order to accomplish the above object, a lamp system according to various embodiments of the present invention includes a lamp housing, an outer lens disposed on at least one surface of the lamp housing, and a sound output device for a lamp, the sound output device including a piezoelectric element stack including a plurality of piezoelectric elements stacked together, a sound driving circuit configured to drive the piezoelectric element stack, and a signal processing circuit connected between the sound driving circuit and the piezoelectric element stack, the signal processing circuit including an impedance compensation filter configured to compensate for an impedance of the piezoelectric element stack that varies according to an output of the sound driving circuit, the impedance compensation filter including reactance components excluding resistive elements, wherein the piezoelectric element stack is coupled to the outer lens or the lamp housing and is configured to vibrate.

### BRIEF DESCRIPTION OF THE DRAWINGS

FIG. 1 is a block diagram illustrating a conventional sound output device for a lamp;

FIGS. 2A, 2B, and 2C are graphs showing the impedance characteristics of the sound output device for a lamp in FIG. 1;

FIG. 3 is a block diagram illustrating a sound output device for a lamp according to the present invention;

FIG. 4 is a circuit diagram illustrating a frequency selection circuit of the sound output device for a lamp according to the present invention;

FIG. 5 is a circuit diagram illustrating a differential line method of the frequency selection circuit according to the present invention; and

FIG. 6 is a circuit diagram illustrating a single-ended line method of the frequency selection circuit according to the present invention.

### DETAILED DESCRIPTION

To explain the present invention, its operational advantages, and the objectives achieved through its implementation, preferred embodiments of the present invention are illustrated and described below with reference thereto.

First, the terms used in this application are merely intended to describe specific embodiments and are not intended to limit the scope of the present invention, and singular expressions may include plural expressions unless the context clearly indicates otherwise. Additionally, in this application, terms such as “comprising” or “having” are intended to indicate the presence of the features, numbers, steps, operations, components, parts, or combinations thereof described in the specification, but do not preclude the presence or addition of one or more other features, numbers, steps, operations, components, parts, or combinations thereof.

In describing the present invention, detailed descriptions of well-known configurations or functions may be omitted so as not to obscure the subject matter of the invention.

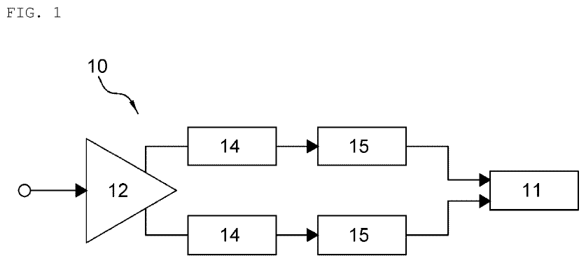

FIG. 1 is a block diagram illustrating a conventional sound output device for a lamp.

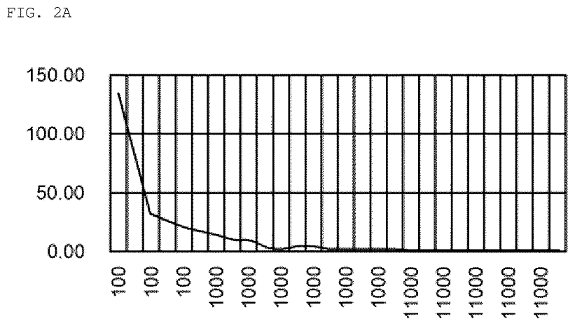

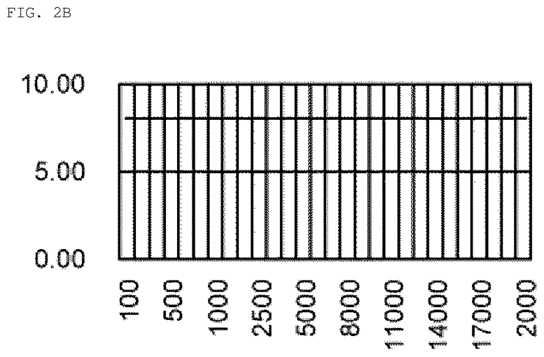

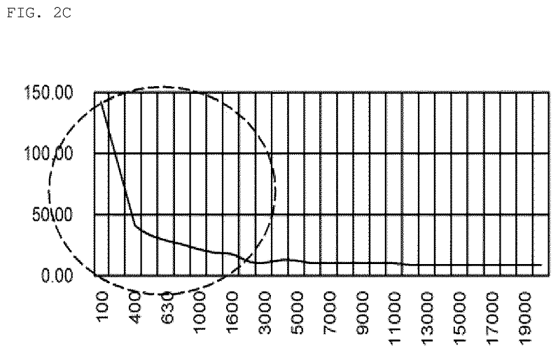

FIGS. 2A, 2B, and 2C are graphs showing the impedance characteristics of the sound output device for a lamp in FIG. 1.

As shown in FIG. 1, in a conventional sound output device for a lamp 10, a series resistor may be added to prevent overcurrent and limit the peak current.

Specifically, the piezoelectric element exhibits a characteristic where impedance decreases as frequency increases, reaching very low impedance close to zero ohms in the high-frequency band. This characteristic can lead to excessive current, i.e., overcurrent, in the high-frequency range. Overcurrent may compromise circuit stability and potentially cause overheating and performance degradation. Therefore, to maintain a certain level of impedance even in the high-frequency band, a resistor is added to the circuit as shown in FIG. 1, preventing impedance from becoming excessively low.

However, as shown in FIG. 2B, the resistor has a constant resistance value regardless of frequency. Consequently, as illustrated in FIG. 2C, while the resistor effectively prevents overcurrent in the high-frequency band, it also increases impedance unnecessarily in the low-frequency band. This unnecessary impedance increase may result in heat generation issues in the low-frequency range. Because low frequencies have longer wavelengths, heat generation tends to be more severe compared to high frequencies, leading to reduced system efficiency and increased energy loss. Thus, the simple addition of a resistor to prevent overcurrent at high frequencies has inherent limitations due to heat generation problems and decreased efficiency.

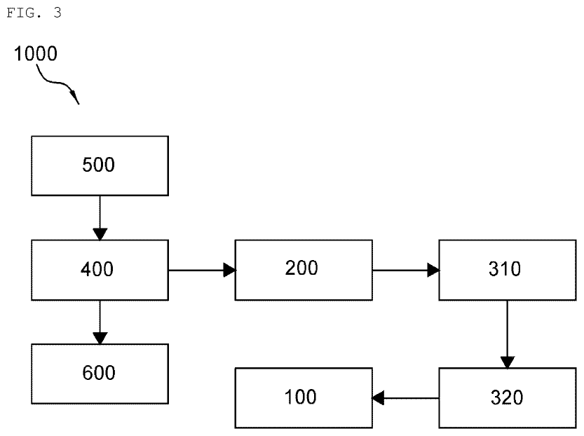

FIG. 3 is a block diagram illustrating a sound output device for a lamp according to the present invention.

As shown in FIG. 3, a sound output device for a lamp 1000 according to the present invention may include a piezoelectric element stack 100, a sound driving circuit 200, and a signal processing circuit.

The piezoelectric element stack 100 may include a plurality of piezoelectric elements stacked on one another. The piezoelectric element stack 100 may be provided on a surface of an outer lens (not shown) or a housing (not shown) of the sound output device for a lamp 1000, and may output sound through vibration when mounted on the surface of the outer lens or housing.

The sound driving circuit 200 may generate power for driving the piezoelectric element stack 100.

The signal processing circuit 300 may be connected between the sound driving circuit 200 and the piezoelectric element stack 100.

Specifically, the signal processing circuit 300 may include an impedance compensation filter 310, which may receive the output of the sound driving circuit 200 and compensate for the varying impedance of the piezoelectric element stack 100 based on the output.

The impedance compensation filter 310 may be composed only of reactance elements, excluding resistive elements.

To compensate for the reduced impedance of the piezoelectric element in the high-frequency band, the impedance compensation filter 310 may include an inductor. The inductor exhibits low impedance in the low-frequency range, but as the frequency increases, its inductive characteristics strengthen, resulting in a gradual increase in impedance. The inductor maintains this inductive behavior up to a certain frequency, i.e., the resonant frequency, after which it begins to exhibit capacitive characteristics, causing the impedance to decrease. Based on the inductive characteristics of the inductor in the frequency range below the resonant frequency, it is possible to effectively compensate for the reduced high-frequency impedance of the piezoelectric element.

To this end, one end of the inductor may be connected to the sound driving circuit 200, and the other end may be connected to the piezoelectric element stack 100. The inductor may compensate for the impedance of the piezoelectric element stack 100 such that the piezoelectric element stack 100 maintains an impedance equal to or greater than a predetermined threshold at frequencies above a certain reference frequency. For example, the inductor may compensate for the reduced impedance of the piezoelectric element stack 100 in a high-frequency band of 4 kHz or higher such that the piezoelectric element stack 100 maintains an impedance of at least 4 ohms.

Preferably, the resonant frequency of the inductor is set significantly higher than the audible frequency range of 20 KHz. This is to ensure that the region in which impedance decreases due to the capacitive characteristics appearing after the resonant frequency does not affect the audible frequency range. Within the audible frequency range, the impedance compensation filter 310 may utilize the inductive characteristics of the inductor to maintain the impedance of the piezoelectric element stack 100 equal to or greater than a predetermined threshold, thereby preventing overcurrent.

Meanwhile, the impedance compensation filter 310 may include a bead to compensate for the decreased impedance of the piezoelectric element in the high-frequency band.

Similar to an inductor, the bead exhibits an increasing impedance as frequency increases up to its resonance frequency, and a decreasing impedance beyond the resonance frequency. Accordingly, the impedance characteristics of the bead in the frequency range below its resonance frequency may be utilized to compensate for the decreased impedance of the piezoelectric element in the high-frequency band.

Compared to an inductor, a bead has a relatively larger resistive component (R component) and a lower quality factor (Q). In contrast, an inductor has a small resistive component and a high quality factor, resulting in low loss. These characteristic differences indicate that each component may be an appropriate choice depending on the specific requirements of the system. For example, since a bead has a large R component, it may be suitable for systems that can tolerate a certain level of signal attenuation and loss in high-frequency bands. On the other hand, an inductor, having a high Q value, may be more suitable for systems that require high efficiency and minimal energy loss.

The selection between a bead and an inductor should be made during the design phase based on the requirements of the system, considering the characteristics of each component. To stably maintain the impedance of the piezoelectric element in a high-frequency band and prevent overcurrent, it is important to select a component capable of providing optimal compensation in a specific frequency range. Accordingly, beads and inductors have different characteristics and applications, and may be used in combination depending on the design purpose of the system. This design approach may complement the high-frequency characteristics of the piezoelectric element and ensure stable and efficient system operation.

Such an impedance compensation filter 310 may effectively address overcurrent issues that could arise due to the characteristics of the piezoelectric element. At the same time, it may minimize heat generation in the low-frequency band and enable stable and reliable signal transmission through efficient impedance compensation in the high-frequency band.

In addition, the signal processing circuit 300 may further include a frequency selection circuit 320.

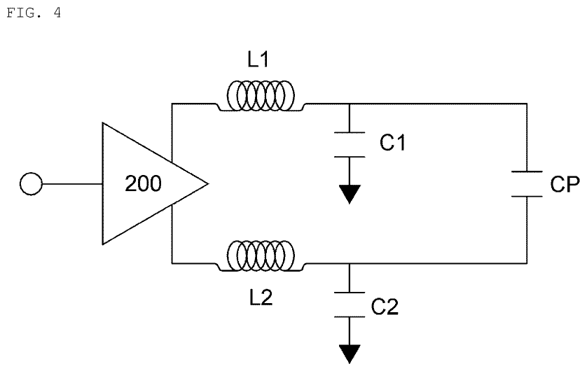

FIG. 4 is a circuit diagram illustrating a frequency selection circuit of the sound output device for a lamp according to the present invention.

The frequency selection circuit 320 may be connected between the sound driving circuit 200 and the impedance compensation filter 310, and may receive the output of the sound driving circuit 200 to selectively pass signals within a specific frequency band.

Specifically, the frequency selection circuit 320 may include a low-pass filter. The low-pass filter selectively passes signals below a certain frequency band and blocks signals above that frequency.

More specifically, as shown in FIG. 4, the low-pass filter may include a first inductor L1 and a first capacitor C1 connected between a first output terminal of the sound driving circuit 200 and a first terminal of the piezoelectric element stack 100.

Here, the first capacitor C1 is positioned between the first inductor L1 and the piezoelectric element stack 100 and is grounded, and the filter may further include a second inductor L2 and a second capacitor C2 connected between the second output terminal of the sound driving circuit 200 and the second terminal of the piezoelectric element stack 100. The second capacitor C2 is positioned between the second inductor L2 and the piezoelectric element stack 100 and may be grounded.

The piezoelectric element stack 100 exhibits low impedance at high frequencies, which may cause overcurrent issues. To address this, an impedance compensation filter 310 using an inductor or bead has been designed. However, due to the capacitive characteristics occurring beyond the resonant frequency, the impedance of the inductor or bead decreases after the resonant frequency. When signals beyond the resonant frequency are transmitted to the output, they may degrade the signal quality of the system, making it necessary to block such signals. Here, a low-pass filter is used to effectively remove high-frequency signals exceeding the resonant frequency.

The resonant frequency of the inductor is typically designed to be much higher than the audible frequency range of 20 KHz. Therefore, the inductor provides stable impedance characteristics within the audible frequency range but may cause signal distortion in the frequency band beyond the resonant frequency due to capacitive characteristics. The low-pass filter blocks these high-frequency signals to prevent signals outside the audible frequency range from being delivered to the output.

Additionally, the cutoff frequency plays an important role in the design of the low-pass filter. The cutoff frequency, which is the maximum frequency allowed to pass through the filter, is generally set to 20 KHz, the upper limit of the audible frequency range. Signals below the cutoff frequency pass through the filter, while signals above it are sharply attenuated. Thus, the low-pass filter selectively passes only the necessary frequency band required by the impedance compensation filter 310 and removes unnecessary high-frequency components.

Meanwhile, the piezoelectric element stack 100 has a characteristic of increased capacitance due to its structure in which multiple layers of electrodes and dielectrics are stacked. Generally, the capacitance of the piezoelectric element stack 100 may be 1 μF or more, which can significantly affect circuit design. In particular, the capacitance of the piezoelectric element acts in parallel within the circuit, which may change the operating characteristics of the low-pass filter.

The low-pass filter serves to block high-frequency components above a certain frequency band in signal processing. The cutoff frequency of the filter is determined by the values of resistance (R) and capacitance (C) in the circuit and is generally set as a fixed value during the design stage. However, when the capacitance of the piezoelectric element stack 100 is connected in parallel to the input terminal of the low-pass filter, the total capacitance increases. As the total parallel capacitance increases, the cutoff frequency becomes lower than the designed value. A lowered cutoff frequency causes more high-frequency signals to be blocked than originally planned, which may lead to degradation in signal quality.

For example, when the capacitance of the piezoelectric element is below a predetermined threshold, and L1 is 10 μH and C1 is 3.3 μF, the capacitance of the piezoelectric element can be ignored, and the cutoff frequency may be 27.7 kHz according to the following equation.

$${f}_{c} = \frac{1}{2 π \sqrt{L \cdot C}} \qquad [ Equation ]$$

However, when the capacitance of the piezoelectric element is very large, for example, 1 μF or more, with L1 of 10 μH and C1 of 3.3 μF, the capacitance C in the above equation becomes C1+2Cp (where

Cp is the capacitance of the piezoelectric element), and the cutoff frequency may become 10.4 KHz.

As a result, the larger the capacitance of the piezoelectric element, the more the frequency response characteristics of the low-pass filter vary, and if not properly compensated, undesired frequency bands may be blocked, negatively affecting system operation. To prevent this problem, it is necessary to adjust the cutoff frequency.

Specifically, when designing the low-pass filter, inductors (first and second inductors) and capacitors (first and second capacitors) are generally used together to block high-frequency components of the signal, as described above. However, since the piezoelectric element acts as a parallel capacitor in the circuit, if its capacitance is sufficiently large, it may be unnecessary to include additional capacitors in the design. This means that the capacitance of the piezoelectric element can be utilized as a component of the low-pass filter, which offers advantages such as material cost reduction and simplified circuit design.

To utilize the capacitance of the piezoelectric element in the filter, the cutoff frequency of the low-pass filter must be accurately calculated. The cutoff frequency fc is determined by the following equation.

$${f}_{c} = \frac{1}{2 π \sqrt{L \cdot C}} \qquad [ Equation ]$$

where C is the total capacitance value calculated as the sum of the piezoelectric element's capacitance and any additional capacitor values, and L is the inductance value used in the low-pass filter. When the capacitance of the piezoelectric element is sufficiently large, the cutoff frequency may be appropriately adjusted with the piezoelectric element alone, without the need for separate capacitors.

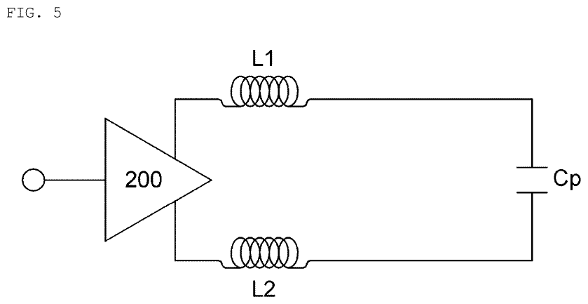

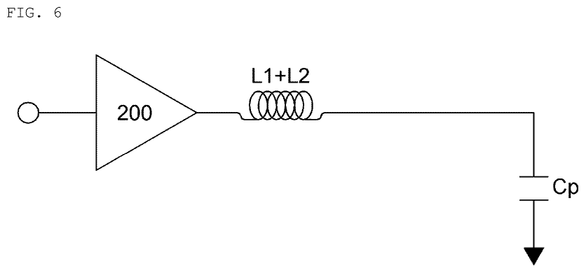

FIG. 5 is a circuit diagram illustrating a differential line method of the frequency selection circuit according to the present invention, and FIG. 6 is a circuit diagram illustrating a single-ended line method of the frequency selection circuit according to the present invention.

As shown in FIGS. 5 and 6, when applying the piezoelectric element to the filter, calculations can be performed using either a differential line method or a single-ended line method. The differential line method calculates based on the voltage between the two terminals of the piezoelectric element and can be calculated according to the following equation, based on the capacitance Cp of the piezoelectric element stack 100 and multiple inductances L1 and L2.

$${f}_{c} = \frac{1}{2 π \sqrt{L \cdot C}} \qquad [ Equation ]$$

Here, C may refer to 2Cp, which excludes C1.

The single-ended line method calculates with respect to one terminal of the piezoelectric element from a single reference point, and can be calculated according to the following equation based on the capacitance Cp of the piezoelectric element stack 100 and multiple inductances L1 and L2 connected in series.

$${f}_{c} = \frac{1}{2 π \sqrt{2 L * {C}_{p}}} \qquad [ Equation ]$$

Both methods reflect the influence of the piezoelectric element's capacitance on the circuit equally, and consequently, the calculated cutoff frequency is the same for both methods. Therefore, appropriately utilizing the capacitance of the piezoelectric element can optimize the design of the low-pass filter, thereby simultaneously ensuring system efficiency and cost-effectiveness.

Meanwhile, the lamp system (not shown) according to the present invention may include a lamp housing, an outer lens disposed on at least one surface of the lamp housing, and the sound output device for a lamp as described above. Here, the piezoelectric element stack included in the sound output device for a lamp may be coupled to the outer lens or the lamp housing so as to be capable of vibrating.

The sound output device for a lamp and a lamp system including the same according to various embodiments of the present invention is advantageous in outputting sound within the sealed structure of the lamp without using a speaker.

While preferred embodiments of the present invention have been described above, the embodiments disclosed herein are intended to be illustrative and not limiting of the scope of the invention. Accordingly, the technical scope of the invention is not limited to the disclosed embodiments but encompasses combinations of the disclosed embodiments, and the scope of the invention is not limited by these embodiments. Furthermore, it will be apparent to those skilled in the art that various changes and modifications can be made to the present invention without departing from the spirit or scope of the attached claims, and all such variations and modifications are intended to fall within the scope of the present invention.

### DESCRIPTION OF REFERENCE NUMERALS

10: sound output device for lamp (conventional)
11: piezoelectric element stack
12: sound driving circuit
13: signal processing circuit
14: LPF
15: resistor
1000: sound output device for lamp
100: piezoelectric element stack
200: sound driving circuit
300: signal processing circuit
310: impedance compensation filter
320: frequency selection circuit
400: controller
500: control power supply unit
600: memory

What is claimed is:

1. A sound output device for a lamp, comprising:
a piezoelectric element stack comprising a plurality of piezoelectric elements stacked together;
a sound driving circuit configured to drive the piezoelectric element stack; and
a signal processing circuit connected between the sound driving circuit and the piezoelectric element stack,
wherein the signal processing circuit comprises an impedance compensation filter configured to compensate for an impedance of the piezoelectric element stack that varies according to an output of the sound driving circuit, and the impedance compensation filter comprises reactance components excluding resistive elements.

2. The device of claim 1, wherein the impedance compensation filter comprises an inductor having one end connected to the sound driving circuit and the other end connected to the piezoelectric element stack, and
wherein the inductor is configured to compensate for the impedance of the piezoelectric element stack and maintain the impedance of the piezoelectric element stack equal to or greater than a predetermined threshold at frequencies above a predetermined reference frequency.

3. The device of claim 1, wherein the signal processing circuit further comprises a frequency selection circuit connected between the sound driving circuit and the impedance compensation filter, and
wherein the frequency selection circuit is configured to selectively pass signals of a specific frequency band in response to an output from the sound driving circuit.

4. The device of claim 3, wherein the frequency selection circuit comprises a low-pass filter configured to pass only frequency components lower than a preset cutoff frequency.

5. The device of claim 2, wherein the inductor compensates for the impedance of the piezoelectric element stack and maintains the impedance of the piezoelectric element stack at 4 ohms or more in a frequency band of 4 kHz or higher.

6. The device of claim 5, wherein a resonance frequency of the inductor is higher than 20 KHz, which is an audible frequency.

7. The device of claim 4, wherein the low-pass filter comprises:
a first inductor and a first capacitor connected between a first output terminal of the sound driving circuit and a first terminal of the piezoelectric element stack, the first capacitor being grounded and disposed between the first inductor and the piezoelectric element stack; and
a second inductor and a second capacitor connected between a second output terminal of the sound driving circuit and a second terminal of the piezoelectric element stack, the second capacitor being grounded and disposed between the second inductor and the piezoelectric element stack.

8. The device of claim 7, wherein the cutoff frequency fc of the low-pass filter is determined based on an inductance L of the inductor, a capacitance C of the capacitor, and an internal capacitance Cp of the piezoelectric element stack, and is defined by Equation 1:
$${f}_{c} = \frac{1}{2 π \sqrt{L ( C + 2 {C}_{p} )}} ,$$
where L refers to the inductance of either the first or second inductor, C refers to the capacitance of either the first or second capacitor, and Cp refers to the internal capacitance of the piezoelectric element stack.

9. The device of claim 4, wherein the low-pass filter comprises:
a first inductor and a second inductor respectively connected in series between a first output terminal and a second output terminal of the sound driving circuit and a first terminal and a second terminal of the piezoelectric element stack,
the first inductor being connected between the first output terminal of the sound driving circuit and the first terminal of the piezoelectric element stack, and
the second inductor being connected between the second output terminal of the sound driving circuit and the second terminal of the piezoelectric element stack.

10. The device of claim 9, wherein the cutoff frequency fc of the low-pass filter is determined based on an inductance L of the inductor and an internal capacitance Cp of the piezoelectric element stack, and is defined by Equation 2:
$${f}_{c} = \frac{1}{2 π \sqrt{L ( 2 {C}_{p} )}} ,$$
where L refers to the inductance of either the first or second inductor, and Cp refers to the internal capacitance of the piezoelectric element stack.

11. The device of claim 4, wherein the low-pass filter comprises a first inductor and a second inductor connected in series between an output terminal of the sound driving circuit and a first terminal of the piezoelectric element stack.

12. The device of claim 11, wherein the cutoff frequency fc of the low-pass filter is determined based on an inductance L of the inductor and an internal capacitance Cp of the piezoelectric element stack, and is defined by Equation 3:
$${f}_{c} = \frac{1}{2 π \sqrt{2 L ( {C}_{p} )}} ,$$
where L refers to the inductance of either the first or second inductor, and Cp refers to the internal capacitance of the piezoelectric element stack.

13. The device of claim 1, wherein the capacitance of the piezoelectric element stack is equal to or greater than 1 μF.

14. A lamp system comprising:
a lamp housing;
an outer lens disposed on at least one surface of the lamp housing; and
the sound output device for a lamp of claim 1,
wherein the piezoelectric element stack is coupled to the outer lens or the lamp housing and is configured to vibrate.

15. A lamp system comprising:
a lamp housing;
an outer lens coupled to the lamp housing;
a piezoelectric element stack attached to the outer lens or the lamp housing, the piezoelectric element stack comprising a plurality of stacked piezoelectric elements and configured to vibrate the outer lens or the lamp housing to output sound; and
a driving circuit coupled to the piezoelectric element stack via an impedance compensation circuit that includes only reactance components and is configured to prevent overcurrent in the piezoelectric element stack.

16. The lamp system of claim 15, wherein the impedance compensation circuit is configured to prevent overcurrent in the piezoelectric element stack at frequencies above 4 kHz by maintaining an impedance of at least 4 ohms.

17. The lamp system of claim 15, wherein the lamp system is configured for installation in a vehicle.

18. The lamp system of claim 15, further comprising a low-pass filter in the impedance compensation circuit, the low-pass filter having a cutoff frequency determined at least in part by an internal capacitance of the piezoelectric element stack.

19. The lamp system of claim 18, wherein the cutoff frequency is approximately 20 KHz.
